(19) United States
(12) Patent Application Publication
(10) Pub. No.: US 2008/0187773 A1
(43) Pub. Date: Aug. 7, 2008

(54) Method for the Protection of Titanium Alloys Against High Temperatures and Material Produced

(75) Inventors: Estibalitz Erauzkin Bilbao, San Sebastian (ES); Sergio Armada Nieto, San Sebastian (ES); Elena Silveira Fernandez, San Sebastian (ES); Georgy Barykin, San Sebastian (ES)

Correspondence Address: CANTOR COLBURN, LLP, 20 Church Street, 22nd Floor, Hartford, CT, 06103, US

(73) Assignee: Fundacion Inasmet, Donostia (ES)

(21) Appl. No.: 11/815,806

(22) PCT Filed: Feb. 11, 2005
(86) PCT No.: PCT/ES05/00071

§ 371 Date: Nov. 14, 2007

(51) Int. Cl. B32B 15/04; B05D 1/02

(52) U.S. Cl. 428/627; 427/427

(57) ABSTRACT

The method allows the production of a cermet coating which is composed of chromium carbide particles embedded in a nickel-chromium matrix, produced by thermal spraying on titanium alloys, which avoids the oxidation and the diffusion of oxygen therein at temperatures of up to 700° C. Additionally, a ceramic layer is deposited on the cermet coating which acts as thermal barrier.

### OBJECT OF THE INVENTION

The method of the invention has the object of protecting titanium alloys against oxidation at high temperatures and against oxygen diffusion, by the deposition of a protective coating on the titanium substrate.

The titanium alloys protected by this coating develop neither a layer of oxide nor the formation of α phase or surface hardening of the titanium, at temperatures of up to 700° C.

### BACKGROUND OF THE INVENTION

The aeronautical industry currently demands materials of reduced weight and high mechanical performance, to reduce the consumption of fuel and/or increase the power of the aircraft.

For this purpose, titanium is a very suitable material since it has high mechanical performance with a very low density, around 4.5 g/cm³, compared with approximately 8 g/cm³ of the superalloys typically used for these high temperature applications.

Nevertheless, titanium alloys show quick oxidation at temperatures over 600° C. and, furthermore, at temperatures over 500° C. they absorb oxygen, which entails the formation of an α phase, causing a surface hardening which makes the alloy fragile and thus limits its application at temperatures below said 500° C.

To avoid oxidation of the titanium at high temperatures, elements are typically added in the alloy, such as, for example chromium or aluminium, which form a continuous and protective oxide layer on the titanium.

However, it has been verified that the addition of chromium to titanium alloys does not reduce the oxidation rate unless added in large proportions, this increase in added chromium causing the loss of the alloy's mechanical properties.

Aluminium has also been used as an alloy element to improve resistance to oxidation at high temperatures but it has been verified that fragile aluminides are formed which also reduce the mechanical properties to a large extent.

Tests have been done with other elements, but in no case has an improvement in the resistance against oxidation at high temperatures been achieved without compromising the mechanical properties of the titanium alloys.

Currently, no titanium alloy is known which minimizes oxidation at a high temperature without reducing its mechanical properties.

Therefore, large efforts have been devoted to producing coatings which avoid oxidation at high temperatures without affecting the mechanical properties of the titanium. These coatings should have the following properties:
Resistance to oxidation at high temperatures.
Density to avoid oxygen diffusion.
Chemical and mechanical compatibility with the substrate.
Reasonable mechanical properties.

One of the most widely used solutions to improve resistance to oxidation of titanium substrates at high temperatures is the aluminization of its surface, producing this coating by depositing a slurry of aluminium on the titanium surface and heating at high temperatures (over 660° C.) in a vacuum, so that the aluminium melts and alloys with the substrate producing a stable intermetallic. The presence of aluminium, easily oxidable, produces a continuous and homogenous oxide layer (Al₂O₃) which avoids the subsequent oxidation of the titanium substrate.

Nevertheless, this method imposes the need for thermal treatments at a high temperature, which typically modifies the metallurgical nature or structure of the titanium base material and produces a degradation of the subsequent mechanical properties. On the other hand, pieces of large size or complex geometry may present distortions or deflections which are difficult to control, limiting the practical applicability of this protection technique.

Another way of producing these aluminizations is by immersion in molten metal or by “pack cementation” (High Temperature Cyclic Oxidation by Subrahmanyam and J. Annapurna, Oxidation of Metals, vol. 26 no. 3/4 1986), although difficulties are observed in the protection of large pieces and the achievement of layers of uniform thickness.

U.S. Pat. No. 5,672,436 discloses aluminization by physical vapour deposition (PVD) which enables much more homogenous coatings to be attained. In this process, the titanium alloy is suspended in an aluminium vapour bath so that the whole surface has the same aluminium concentration, having the drawback that the process should be performed in a closed chamber and at the sufficient temperature to form TiAl₃.

Another alternative is the substitution of aluminium by chromium, so that the coating is formed by a ceramic layer of Cr₂O₃ instead of Al₂O₃, as disclosed in U.S. Pat. No. 5,098,540 wherein the chromium is deposited on the titanium substrate using physical vapour deposition (PVD) techniques.

Although the chromium coatings thus formed adhere better to the titanium substrate, they have a low vapour pressure at high temperatures and, in relation to the aluminium oxide generating treatments, a very reduced protective capacity at high temperatures.

To avoid the formation of undesired intermetallics, of fragile nature, in the Ti—Al interface, elements can be used with high melting point, such as, for example, platinum, which also have high resistance to oxidation, these elements acting as diffusion barriers. These processes consist of a first electrochemical deposition of platinum and its subsequent heating to favour the diffusion on the titanium. Next, aluminium is deposited and a diffusion process is again provoked, giving rise to platinum aluminide.

This process does not completely avoid the presence of a fragile layer but prevents the subsequent diffusion of the elements. A process of this type is disclosed in Patent GB 2,290,309.

Another type of coating designed to protect titanium alloys at temperatures over 500° C., are those based on the Ti—Al—Cr combination, which are deposited by “magnettron sputtering” technologies, forming a continuous and protective layer of alumina.

These coatings have the drawback of the possible formation of fragile phases, such as, for example, Ti(Cr,Al)₂, which largely reduce the fatigue of the substrate.

Finally, U.S. Pat. No. 5,077,140 discloses a protective coating by the deposition of MCrAl or MCr, where M is a metal selected from iron, nickel and cobalt. These coatings can be produced by chemical vapour deposition, physical vapour deposition or by thermal plasma spraying, the latter technique being the most suitable.

One of the advantages of these types of coatings is their high resistance to thermal cycling, although no data is given on the possible formation of the fragile α layer, or on the possible reduction of the properties of resistance to fatigue of the substrate. U.S. Pat. No. 5,077,140 indicates the possibility of improving the substrate's properties by subsequent thermal treatments which improve adherence between the coating and the substrate, as well densification of the coating.

### DESCRIPTION OF THE INVENTION

The method of the invention allows improving the characteristics of the treatments used at present and does not have limitations in the use of the titanium alloys at high temperatures. This new method is based on the production of a coating which avoids oxidation and oxygen diffusion, and, therefore, the formation of the fragile α phase surface layer, in the applications of titanium alloys at a high temperature.

The coatings applied to the titanium substrate do not show interdiffusion with the substrate during their deposition or during their use, up to a temperature of 700° C.

The coating deposited in accordance with the method object of the invention is composed of a nickel-chromium alloy with chromium carbide particles embedded in the matrix.

This invention also includes the possibility of depositing an additional layer, of a ceramic material, preferably partially yttria-stabilized zirconium, on the previous layer.

The chromium carbide particles (Cr₃C₂, Cr₇C₃ or Cr₂₃C₆) can be found in proportions of up to 85% by weight of the total.

The metal matrix is a nickel-base metal alloy with contents of other metallic elements such as chromium, iron, cobalt, silicon and molybdenum, up to 25% by weight.

The chromium carbide coatings are produced by thermal spray technologies and, preferably, by HFPD (HIGH FREQUENCY PULSE DETONATION) thermal spray technology since it is necessary that the powder particles of the coating reach great velocity to attain as dense a coating as possible. Otherwise, a coating would be produced with high porosity and bad coherence which enables the diffusion of oxygen through it.

During the spraying process, the substrate must be kept refrigerated to avoid oxygen diffusing on the titanium surface, which makes it become fragile. Refrigeration is also necessary to minimize the stresses that may generate inside the coating.

The thickness of the chromium carbide coating may go from tens of microns to several hundreds of microns.

It has been verified that in samples of β or α titanium, protected with the chromium carbide/nickel-chromium coating object of the invention, exposed at high temperatures (700° C. for 100 hours), neither the presence of oxide on the substrate-coating interface nor the formation of an α phase, produced by the diffusion of oxygen inside the titanium, are observed.

Furthermore, the presence of chromium in the coating facilitates the formation of chromium oxide that avoids oxygen diffusion and, therefore, the contamination of the titanium.

It has also been verified that there does not exist diffusion processes between the elements of the chromium carbide coatings and the substrate after exposure at high temperatures, so the formation of intermetallics is avoided in the substrate-coating interface which typically makes the unit fragile.

In addition to protecting the titanium from oxidation, the chromium carbide coatings embedded in the nickel-chromium matrix proposed can also be used as an anchoring layer in thermal barriers, up to 700° C., since its thermal expansion coefficient is intermediate between the titanium and the ceramic layers typically used for this purpose.

In relation to these ceramic layers that act as thermal barriers, the present invention also discloses the deposition thereof on the protective chromium carbide coating. These ceramic layers, preferably partially yttria-stabilized zirconium are also deposited by thermal spray technologies, preferably plasma spraying.

### DESCRIPTION OF THE DRAWINGS

To complement the description being made and in order to aid towards a better understanding of the characteristics of the invention, in accordance with a preferred practical embodiment thereof, 3 figures are attached as an integral part of said description which illustrate the effectiveness of the coating against the formation of the alpha phase surface layer after the material has been exposed to a temperature of 700° C. for 100 hours.

FIG. 1 shows a badly deposited coating (1) which shows the formation of the α phase layer (2) after exposure to a high temperature, as well as titanium β21 (3). In this FIG. 1, the formation of α phase in a sample of Titanium β21 coated with a nickel-chromium alloy with particles of chromium carbide embedded in the matrix, by a non-optimized spray method and after exposure to 700° C. for 100 hours.

FIG. 2 shows the appearance of the material (3) after the same exposure (700° C. for 100 hours) when the coating (1) has been correctly deposited, in accordance with the method described in the patent, as can be seen there is no formation of the alpha phase layer under the coating. In FIG. 2, the appearance of a sample of Titanium β21 (3) coated by the method described in this application after exposure to 700° C. for 100 hours. The formation of the α phase surface layer on the titanium substrate is not observed.

FIG. 3 shows a micrograph of the coating generated after the deposition of a second additional layer (4) of a ceramic material, in particular partially yttria-stabilized zirconium.

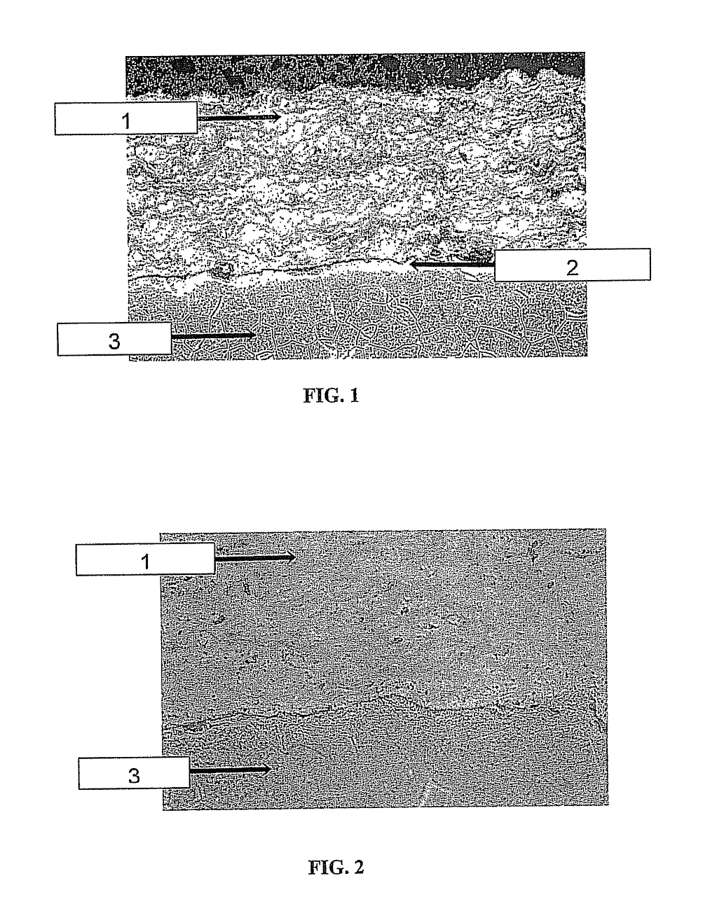

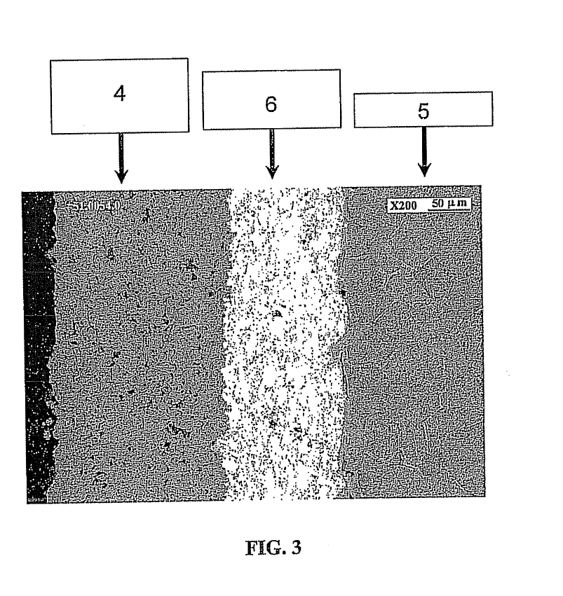

Said FIG. 3 shows the micrograph of the coating formed by two layers. The outermost, which appears with a darker colour (4) is the partially yttria-stabilized zirconium, that situated between the previous (4) and the titanium substrate β21 (5), which appears with a lighter colour, is that of chromium carbide/nickel-chromium (6).

### EXAMPLE OF EMBODIMENT

The method described consists of the deposition of a layer of Cr₃C₂ Ni—Cr by HFPD (HIGH FREQUENCY PULSE DETONATION) thermal spray technology on a commercial β21 titanium substrate. Additionally, the method describes the deposition of a second layer on the previous of 8YSZ: ZrO₂—8Y₂O₃, by thermal plasma spraying.

Before the deposition, the titanium substrate is subjected to peening and then to blasting to eliminate the possible particles left incrusted since the presence thereof may contribute to small quantities of air being trapped in the substrate-coating interface, which would favour the formation of the fragile α phase on the titanium.

The blasting process is also necessary to achieve good adherence between the coating and the substrate since it largely depends on the initial roughness of the substrate.

For the deposition of the first layer (Cr₃C₂ Ni—Cr), the gases used for the thermal spraying were propylene (between 35 and 55 slpm) and oxygen (between 130 and 155 slpm) at a detonation frequency between 60 and 90 Hertz.

As starting material for the production of the coating, powder composed of chromium carbide and nickel-chromium with 80% of carbides and 20% of metal matrix was used.

The coating produced, with an average thickness of 160 microns, shows good adherence to the substrate, with the absence of diffusion processes on the interface between the substrate and the coating.

For the deposition of the second layer (YSZ) the gases used for the thermal spraying were argon and hydrogen at an approximate intensity of 700 A.

As starting material for the production of the coating, Amperit 825.0 commercial powder was used.

The coating produced, with an average thickness of 180 microns, shows good adherence to the first layer since, as has been previously commented, it functions as anchoring layer.

The sample produced was tested at 700° C. for 100 hours, showing neither the start of oxidation in the titanium substrate nor the formation of the fragile α layer.

To determine the presence of oxygen in the substrate-coating interface, the measure of hardness can be used throughout the sample since, when the diffusion of oxygen is produced, the hardness in the interface area is greater than the hardness of the core. In particular, the hardness values HV_{0.1} of the sample tested are very similar to the surface of the coating and in the centre of the substrate, as indicated in the following table:

| | Measuring area | | |
|---|---|---|---|
| | In the coating- | 500 μm from | In the centre of |
| HV_{0.1} | base interface | the interface | the base material |
| Ti β21 at 700° C. | 322 | 298 | 290 |
| for 100 h | | | |

Neither are degradation processes, nor other structural changes observed within the coating.

Furthermore, the coating has a thermal expansion coefficient very similar to that of titanium, which means it does not show fractures or delaminations, during the thermal cycling to which the coating produce is subjected, i.e. 200 cycles at 600° C. during 1 hour and cooling to 50° C.

The coated samples were tested in traction and no difference was observed in any of the values produced compared to those of the uncoated material. The fatigue tests showed that the titanium β21 with the coating object of the invention, withstood loads of up to 450 MPa during more than one million cycles.

The main advantage of this coating is the absence of diffusion processed in the interface or in substrate, which avoids the formation of intermetallic compounds which make it fragile, as well as the absence of the heating of the substrate during the deposition that avoids the formation of undesired microstructural changes in the titanium.

1. Method for the protection of titanium alloys against high temperatures, characterized in that it comprises the deposition of a cermet coating on the titanium alloy which avoids the oxidation and oxygen diffusion of said alloy at temperatures over 500°.

2. Method for the protection of titanium alloys against high temperatures according to claim 1, characterized in that the cermet coating is composed of chromium carbides embedded in a metal matrix.

3. Method for the protection of titanium alloys against high temperatures according to claim 1, characterized in that the metal matrix is a nickel-base metal alloy with contents of other metallic elements selected from chromium, iron, cobalt, silicon and molybdenum.

4. Method for the protection of titanium alloys against high temperatures, according to claim 1, characterized in that the cermet coating is produced by thermal spraying.

5. Method for the protection of titanium alloys against high temperatures according to claim 4, characterized in that the thermal spray method is a HFPD (high frequency pulse detonation) thermal spray method.

6. Method for the protection of titanium alloys against high temperatures according to claim 5, characterized in that the thermal spraying is performed using propylene (between 35 and 55 slpm) and oxygen (between 130 and 155 slpm) as gases and at a detonation frequency between 60 and 90 Hertz.

7. Method for the protection of titanium alloys against high temperatures, according to claim 1, characterized in that it additionally comprises the deposition of a layer of ceramic material, on the cermet layer.

8. Method for the protection of titanium alloys against high temperatures, according to claim 7, characterized in that the layer of ceramic material is a layer of partially yttria-stabilized zirconium.

9. Method for the protection of titanium alloys against high temperatures, according to claim 7, characterized in that the deposition of the layer of ceramic material is performed by a thermal plasma spray method.

10. Method for the protection of titanium alloys against high temperatures, according to claim 9, characterized in that the gases used for the thermal spraying are argon and hydrogen, performing the process at an approximate intensity of 700 A.

11. Material composed of a coating and a substrate characterized in that the coating consists of a cermet layer deposited on the substrate which is a titanium alloy with the special characteristic that the formation of an alphaα phase is not produced in the substrate interface, as a consequence of the deposition process of the cermet layer.

12. Material, according to claim 11, characterized in that the cermet coating is composed of chromium carbides embedded in a metal matrix.

13. Material according to claim 12, characterized in that the metal matrix is a nickel-base metal alloy with contents of other metallic elements selected from chromium, iron, cobalt, silicon and molybdenum.

14. Material according to claim 11, characterized in that the cermet coating is produced by thermal spraying.

15. Material according to claim 14, characterized in that the thermal spray method is a HFPD (high frequency pulse detonation) thermal spray method.

16. Material according to claim 15, characterized in that the thermal spraying is performed using propylene (between 35 and 55 slpm) and oxygen (between 130 and 155 slpm) as gases and at a detonation frequency between 60 and 90 Hertz.

17. Material according to claim 11, characterized in that it additionally comprises a ceramic layer deposited on the cermet layer.

18. Material according to claim 17, characterized in that the layer of ceramic material is a zirconium layer partially stabilized with yttria.

19. Material according to claim 17, characterized in that the deposition of the layer of ceramic material is performed by a thermal plasma spray method.

20. Material according to claim 19, characterized in that the gases used for the thermal spraying are argon and hydrogen, performing the process at an approximate intensity of 700 A.
